(19) United States
(12) Patent Application Publication
(10) Pub. No.: US 2026/0193081 A1
(43) Pub. Date: Jul. 9, 2026

(54) PROCESS FOR CONVERSION OF ENERGY IN THE FORM OF PROCESS HEAT AND HYDROGEN

(71) Applicant: Technische Universität Darmstadt, Darmstadt (DE)

(72) Inventors: Andreas DREIZLER, Bensheim (DE); Christian HASSE, Darmstadt (DE); Jannik NEUMANN, Darmstadt (DE); Paulo DEBIAGI, Darmstadt (DE)

(73) Assignee: Technische Universität Darmstadt, Darmstadt (DE)

(21) Appl. No.: 19/128,330

(22) PCT Filed: Nov. 7, 2023
(86) PCT No.: PCT/EP2023/081035

§ 371 Date: May 8, 2025

(30) Foreign Application Priority Data
Nov. 10, 2022 (DE) 10 2022 129 816.7

(51) Int. Cl. C01B 3/10; C01F 7/428

(52) U.S. Cl. CPC C01B 3/10; C01F 7/428; C01B 2203/148; C01B 2203/84; C01P 2004/64

(57) ABSTRACT

A processes (1) for conversion of energy in the form of process heat (7) and hydrogen (3) is disclosed. Aluminum (10) is reacted with water (6) at elevated temperature in an aluminum reaction chamber (9) in an aluminum oxidation step (11) and thus oxidized to form aluminum oxide (12). This liberates process heat (7) and hydrogen (3). The hydrogen (3) liberated in the reaction of aluminum (12) and water (6) is at least partially supplied to a hydrogen reaction chamber (5). The hydrogen (3) reacts with oxygen (4) to form water (6) in a water production step (2). The water (6) previously produced from the hydrogen (3) is supplied to the aluminum reaction chamber (11) for oxidation of the aluminum (12).

### CROSS-REFERENCE TO RELATED APPLICATION

This application is a national stage application, filed under 35 U.S.C. § 371, of International Patent Application PCT/EP2023/081035, filed on Nov. 7, 2023, which claims the benefit of German Patent Application DE 10 2022 129 816.7, filed on Nov. 10, 2022.

### TECHNICAL FIELD

The disclosure relates to a process for conversion of energy in the form of process heat and hydrogen, wherein aluminum is reacted with water at elevated temperature in an aluminum reaction chamber in an aluminum oxidation step and thus oxidized to form aluminum oxide, wherein this liberates process heat and hydrogen during the reaction.

### BACKGROUND

As a greenhouse gas, carbon dioxide is partly responsible for the greenhouse effect and therefore global warming. The majority of the carbon dioxide emitted worldwide forms due to combustion, i.e. the oxidation and processing of carbon-containing fossil energy carriers such as oil or coal. In addition to the gaseous by-products of oxidation, which also include carbon monoxide, large quantities of particulate matter in the form of nanoparticles are emitted, which can lead to a negative impact on the air quality, in particular in the winter months, and this mainly has an adverse effect in metropolitan areas.

To counteract this problem, metals are therefore under discussion as carbon-free energy carriers. Homogeneous chemical elements having metallic bonding of their atoms to one another in the zero oxidation state are referred to in the following as metals in summary. The metal species obtained in the oxidation of metals, such as metal oxides, are referred to as oxidized metal in the following.

Metals exhibit a high potential for storing energy and for liberating it at a desired point in time during controlled oxidation. For example, the chemical energy stored in a metal can be converted into electrical energy via oxidation processes in the consumer itself. This conversion usually does not produce greenhouse gases or carbon monoxide. The oxidized metal can then again be reduced to the metal in a separate process and can be repeatedly used for storing energy. If the reduction of the oxidized metal is powered by renewable source such as wind turbines or photovoltaic systems, this allows energy to be provided in an environmentally friendly manner. This provides a significant advantage over conventional carbon-containing energy carriers, which cannot be recycled after oxidation and therefore cannot be recirculated.

The ability of the metal energy carrier to be transported introduces the option of storing renewable energy by means of chemical reduction in the energy carrier in windy and sunny regions, potentially far away from the consumer, and then using it all over the world.

In this case, iron, copper, nickel, manganese, silicon and also aluminum have been found to be advantageous as metals. It is already known that aluminum can be reacted with air or oxygen in an aluminum reaction chamber, as a result of which the aluminum is oxidized to form aluminum oxide in an aluminum oxidation step. In this case, this reaction is exothermic, wherein the oxidation temperature of the aluminum during the reaction can exceed the boiling point of aluminum on one hand and also of aluminum oxide on the other hand. In this case, the aluminum or aluminum particles used can transition into the gas phase, wherein, after condensation of the gaseous aluminum particles in lower-temperature regions, nanoparticles in a size range of a few nanometers can form, which have a smaller diameter than the original aluminum particles used. These nanoparticles have the drawback that they can only be separated from the other reaction products and thus returned to the recycling cycle with a great deal of effort.

The reaction of aluminum with water, however, provides the advantage that the boiling points are not exceeded at a slightly elevated pressure either of the metal or the metal oxide and also that, in the reaction of aluminum with water, hydrogen is likewise formed in addition to aluminum oxide and energy in the form of process heat. In this case, the hydrogen formed can likewise be advantageously used in addition to the oxidation process heat that is formed.

In the conversion of the chemical energy of aluminum into thermal energy, it is particularly desirable to select and regulate the oxidation temperature in a targeted manner, wherein two opposing processes need to be taken into account. First, the lowest possible oxidation temperature of the aluminum provides the advantage that only a few nanoparticles are formed during the oxidation, and second, it is advantageous for the process heat to be able to be recovered at the highest possible oxidation temperature. It is therefore particularly advantageous for the temperature of the oxidation of the aluminum to remain slightly below the boiling point of aluminum during the controlled oxidation.

Furthermore, it is desirable for the process of energy conversion from the metal to be able to be carried out at the location at which oxidation takes place as efficiently as possible and without the formation of nanoparticles.

### SUMMARY

A problem addressed by the present invention is that of further improving the process already known from the prior art, wherein the efficiency is intended to be kept as high as possible and the proportion of the nanoparticles obtained during the oxidation is intended to be kept as low as possible.

The problem is solved in that the hydrogen liberated in the reaction of aluminum and water is at least partially supplied to a hydrogen reaction chamber, wherein the hydrogen reacts with oxygen to form water, and in that the water previously produced from the hydrogen is supplied to the aluminum reaction chamber for oxidation of the aluminum.

In the following, “aluminum” is understood to mean the metal aluminum, while the term “aluminum oxide” is understood to mean the ternary and completely oxidized aluminum oxide Al₂O₃.

The two-stage reaction-chamber concept comprising an aluminum reaction chamber and a hydrogen reaction chamber makes it possible to keep the oxidation temperature of the reaction of the aluminum with water to form aluminum oxide in the aluminum reaction chamber below the threshold temperature, i.e. below the boiling point of aluminum and also below the boiling point of aluminum oxide, in a simple manner. In this case, the oxidation temperature of the aluminum can also be regulated by the targeted input of water formed in the hydrogen reaction chamber. This can be achieved both by the quantity of water supplied to the aluminum reaction chamber and also by the temperature of the supplied water. Furthermore, the oxidation temperature can likewise be regulated by the quantity of aluminum input into the aluminum reaction chamber.

Expediently, the water introduced into the aluminum reaction chamber is conditioned and preferably has an elevated temperature which is above the ignition temperature of the reaction of aluminum with water. Owing to the exothermic reaction of the hydrogen with oxygen to form water, water can be provided at the desired elevated temperature in a simple manner, wherein it does not have to be heated separately by the input of energy from an external energy source.

Furthermore, the process allows energy to be flexibly extracted in the form of process heat and hydrogen. In this case, process heat can be removed both from the hydrogen reaction chamber, which is heated by the highly exothermic, very rapid reaction of the hydrogen with oxygen or air, and from the aluminum reaction chamber. By way of example, the process heat removed from the cycle can be used to heat water and form steam by means of a heat exchanger, this water and steam then being able to be converted into power. In a similar way, the hydrogen formed can be converted into power by means of a fuel cell or can be supplied to the cycle again for a further reaction in the hydrogen reaction chamber in order to produce the water. This makes it possible, without removing the hydrogen, to circulate the hydrogen in a cycle while it is oxidized in the hydrogen production step with supplied oxygen to form water. The water produced is then oxidized to form aluminum oxide in the aluminum oxidation step, wherein hydrogen is formed again, which can be supplied to the hydrogen reaction chamber again to produce the water.

The aluminum oxide formed in the reaction can again be reduced to form aluminum using the Hall-Héroult process. Furthermore, it is likewise possible for the hydrogen to be used separately in a separate cycle for reducing the aluminum oxide that accumulates.

The use of aluminum as a chemical energy store is advantageously useful in comparison with other chemical energy stores in particular owing to the high energy density in a range of 23 kWh/dm³. Furthermore, owing to its non-toxic character, aluminum can be handled in a simple manner, wherein no special protective measures are required. It has been demonstrated that, by reacting the aluminum with water at elevated temperatures, the passivation layer of the aluminum on the surface can be disregarded and a quantitative reaction of the aluminum with water is still possible.

In particular, the process can be used for the decentralized provision of energy in industry and chemical parks and also for the decentralized provision of energy in power plants. As already mentioned, in this case, the process can either be used for the polygeneration of energy in the form of process heat and hydrogen, in particular in industry or in chemical parks, wherein the process heat and the hydrogen can be used, or, depending on the area of application, only the process heat can be used, wherein the hydrogen can be supplied to the cycle again.

Furthermore, it is likewise provided that the hydrogen is used in an excess in the water production step to produce the water. To produce water from hydrogen and oxygen, two hydrogen molecules react spontaneously with one oxygen molecule in accordance with the reduced reaction equation H₂+½O₂→H₂O. By means of a superstoichiometric reaction, i.e. a reaction with an excess of hydrogen in which a greater quantity of hydrogen is supplied to the reaction than is actually required for the reaction according to the above reaction equation, the product of the reaction that is formed is a mixture of water and low quantities of hydrogen. The low residual quantity of hydrogen is no longer disadvantageous for the further reaction of the water with the aluminum, however. The stoichiometric to superstoichiometric reaction of the hydrogen with the oxygen can result in the oxygen reacting completely with the hydrogen and no oxygen being able to enter the aluminum reaction chamber, such that the hydrogen that is formed during the reaction of aluminum and water can be recovered and the aluminum does not react with oxygen directly to form aluminum oxide while bypassing the formation of hydrogen. An excessively elevated concentration of hydrogen is not desired either, since the aluminum oxide formed can otherwise be reduced in the aluminum reaction chamber back to aluminum in an uncontrolled manner.

In a stoichiometric reaction in accordance with the above reaction equation, however, a complete reaction to form water can be achieved, which, aside from water, does not have any by-products which could interfere with the desired oxidation path.

In this case, the required oxygen can either be introduced into the hydrogen reaction chamber directly as oxygen or in a gas mixture, such as air. The direct reaction of the hydrogen with oxygen provides the advantage that undesired side reactions of the reaction of highly reactive hydrogen with constituents of air can be prevented. Furthermore, in the subsequent reaction of the aluminum, in particular at higher temperatures, undesired reactions of the aluminum with nitrogen compounds, for example, would also be conceivable.

The ignition temperature of the reaction of aluminum with water is in the order of magnitude of approx. 2200° C., depending on the prevailing conditions. Therefore, it is advantageously provided that, in the water production step, water is produced at a temperature greater than 2200° C., preferably greater than 2500° C., and in particular greater than 2800° C., for introduction into the aluminum reaction chamber. The very rapid reaction of hydrogen with oxygen results in high temperatures in the hydrogen reaction chamber, in particular when oxygen is provided directly and not in a gas mixture. Therefore, it is particularly advantageous for the reaction of the hydrogen with oxygen in the water production step to be regulated such that the temperature of the water produced, or more specifically the steam, is above 2200° C., preferably above 2500° C., and in particular above 2800° C., such that the ignition temperature of the aluminum for initiating the oxidation of the aluminum in the aluminum reaction chamber is reached. The oxidation temperature of the aluminum can also be influenced by the temperature of the water introduced into the aluminum reaction chamber.

Furthermore, it may be advantageous for the temperature of the water produced in the water production step to be higher the longer the transport path of the produced water to the aluminum reaction chamber, in order to make it possible for the water flowing into the aluminum reaction chamber to have the required ignition temperature.

In this case, the oxygen or air required for the reaction can be provided at room temperature and advantageously does not need any heating before the reaction with the hydrogen.

In order to avoid a controlled reaction of the hydrogen with oxygen as far as possible and to regulate the reaction temperature, it can also be provided that, to regulate the temperature of the produced water in the hydrogen reaction chamber, water from a water reservoir is introduced into the hydrogen reaction chamber in order to provide water at a desired temperature. Feeding in additional water both makes it possible to lower the temperature of the hydrogen reaction chamber, in order to minimize the thermal load on the reaction chamber, and also the formation of nitrogen oxide can thus be prevented when the process is conducted with air instead of pure oxygen. In addition to the hydrogen, the water required for introduction can be removed from the process itself. To do this, more water can be supplied to the aluminum oxidation step in the aluminum reaction chamber than is required for the reaction to form the aluminum oxide. This excess water can, where necessary after cooling by means of a heat exchanger, be supplied to the hydrogen reaction chamber for cooling.

It is likewise provided that, in the aluminum oxidation step, aluminum having a particle size between 1 and 1000 μm, preferably between 2 and 80 μm, and in particular between 5 and 40 μm, is used. Here, the particle size is understood to be the average equivalent diameter of the particles. In order to allow for the most complete and rapid possible reaction of the aluminum with water, the aluminum used is advantageously present as aluminum particles having a size in the micrometer range. In this case, the oxidation of the aluminum in the micrometer range can be described on the basis of the adiabatic flame temperature T_{f} and the steam pressure T_{b} of the aluminum oxide that is formed. In order to prevent the uncontrolled and undesired evaporation of the aluminum during the reaction and therefore the formation of difficult-to-separate particulate matter in the form of nanoparticles, which make it difficult to recycle the metal oxide, it is advantageous for the ratio of T_{f} to T_{b} to be <1.

The aluminum particles introduced into the aluminum reaction chamber at least partially melt due to the exothermic reaction of aluminum with the water, meaning that the aluminum is largely or completely in liquid form. Owing to the water as an oxidizer, during the oxidation of the aluminum an oxide layer that grows from the particle surface towards the particle core forms on the aluminum particles, which surround the potentially still partially solid particle cores. In this case, the mass of the aluminum-aluminum oxide particle increases due to the oxidation by the “addition” of oxygen. If the metal-oxide layer is porous, the density of the metal oxide is lower than that of the metal. The size of the oxidized metal particle then increases compared with the original metal particle. This makes it easier to effectively separate the aluminum oxide particles that form, meaning that, as far as possible, a complete oxidation cycle and subsequent reduction in a separate process is made possible.

Advantageously, the oxidation reaction of the aluminum therefore takes place in a C-type reaction that proceeds heterogeneously on the surface of the aluminum, wherein, in the process, neither the aluminum nor its oxides that form transition into the gas phase and form nanoparticles (J. M. Bergthorson, S. Goroshin, M. J. Soo, P. Julien, J. Palecka, D. L. Frost und D. J. Jarvis, Applied Energy, 2015, 160, 368-382).

It is also provided that, in the aluminum oxidation step, at least partially oxidized aluminum also is or can be oxidized with water in the aluminum reaction chamber in addition to aluminum. At least partially oxidized aluminum, such as aluminum hydroxide Al(OH)₃, can also be added to the aluminum. In this case, these energy carriers, which are low-energy in comparison with aluminum owing to the at least partial oxidation, can in particular be added to the aluminum to regulate the oxidation temperature or can also be separately supplied to the aluminum reaction chamber. In addition to aluminum species, other metals or oxidized metal species can also be used and added to the aluminum and/or the at least partially oxidized aluminum.

In order to prevent or at least minimize, as far as possible, the formation of particulate matter in the form of nanoparticulate aluminum oxide, it is advantageous for the aluminum used and introduced into the aluminum reaction chamber to be completely oxidized in accordance with the C type to form aluminum oxide. In addition to providing aluminum in the micrometer range, the complete reaction is also dependent on the oxidizer provided. Therefore, it is advantageously provided that the water used for the oxidation of the aluminum is used in an excess. For this purpose, the molar ratio λ_{H2O} of the water introduced into the aluminum reaction chamber to the stoichiometrically required water can in particular be selected such that λ_{H2O} is ≥1. In particular at temperatures above 2000° C., a ratio of λ_{H2O}<1 being used results in the formation of aluminum nanoparticles and other undesired particles, since incompletely oxidized aluminum oxide phases with aluminum in the oxidation stage +1 such as Al₂O.

According to an advantageous implementation, it is optionally provided that, at a specified pressure, an oxidation temperature of the aluminum in the aluminum oxidation step is below the boiling temperature of aluminum and aluminum oxide. In this way, the formation of aluminum oxide nanoparticles can be effectively prevented or at least largely minimized. Here, nanoparticles of aluminum oxide can in particular form when the temperature during the oxidation of the aluminum is above the boiling temperature of the aluminum at a suitable pressure. First of all, during the transition of the aluminum into the gas phase and gas phase oxidation that takes place therein, nanoparticles of aluminum oxide can be formed, in particular in a subsequent condensation process. In this case, a gas phase transition is, however, also possible below the boiling temperature of the aluminum if the steam pressure of the aluminum particles is sufficient for such a transition. Furthermore, nanoparticles can likewise be formed if the oxidation temperature exceeds the boiling point of aluminum oxide. In this case, in a first step, the aluminum can be oxidized to form aluminum oxide, wherein the temperature of the particle then increases further owing to the exothermic oxidation reaction and a gas phase transition can take place. If the aluminum oxide then condenses in lower-temperature regions, this can result in undesired nanoparticle formation.

This nanoparticle formation can be largely prevented by suitably regulating and specifying the oxidation temperature. This is because the formation of aluminum oxide nanoparticles, as are formed when aluminum evaporates, makes it difficult to separate and recycle the aluminum oxide from the hydrogen that is likewise formed.

In order to generate only a low quantity of nanoparticles during the oxidation of the aluminum as far as possible, it is advantageous for, at a specified pressure, the oxidation temperature of the aluminum in the aluminum oxidation step to be below the boiling temperature of aluminum, and for the water used for the oxidation of the aluminum to be used in an excess, such that the aluminum is completely oxidized by the water at a temperature below the boiling temperature of aluminum. It has been found that the formation of aluminum oxide nanoparticles can be controlled in particular by controlling the physical state of the aluminum and by the quantity of the supplied oxidizer.

The oxidation temperature of the aluminum used is preferably below the boiling temperature of the aluminum. This is because, if it is above the boiling temperature, the aluminum used evaporates for the most part, wherein, in a subsequent condensation process, nanoparticles of aluminum oxide can form, which have a smaller diameter than the original aluminum particles used. These nanoparticles have the drawback that they can only be separated from the other reaction products, such as the hydrogen, and thus returned to the recycling cycle with a great deal of effort.

The formation of nanoparticles can also be regulated by the quantity of water used. By means of C-type complete oxidation of the aluminum, fewer aluminum species are produced in the gas phase and therefore fewer nanoparticles are produced, too. Furthermore, if more water is used than is actually stoichiometrically consumed for the oxidation of the aluminum, side reactions of the aluminum with water and therefore, for example, the formation of incompletely oxidized aluminum species, such as Al₂O, are prevented. An incomplete reaction would mean that the quantity of energy that can be achieved from the oxidation would be less than for a complete reaction.

It is advantageous to carry out the oxidation of the aluminum at elevated pressure. Therefore, it is provided that the oxidation of the aluminum in the aluminum oxidation step is carried out at a pressure between 1.7 bar and 50 bar, preferably at a pressure between 2 and 20 bar, and in particular at a pressure between 5 and 10 bar. Therefore, both the hydrogen storage and the process intensification can be facilitated. Furthermore, at elevated pressure, i.e. at pressures of 1.7 bar, the temperature of the aluminum particles can be kept below the boiling point in a simple manner, since the boiling temperature is also a function of the pressure. The higher the pressure, the higher the oxidation temperature can be without the aluminum used evaporating. A higher oxidation temperature is associated with elevated process heat here. Therefore, the gas phase transition and, associated therewith, also the nanoparticle formation in the gas phase can be largely prevented or at least reduced.

Advantageously, the aluminum oxide formed during the oxidation of the aluminum with water is separated from the hydrogen that is likewise formed. In this way, the aluminum oxide can be collected and reduced to metal again for storing energy. Therefore, it is optionally provided that the aluminum oxide formed in the aluminum oxidation step has a larger particle size than the aluminum used for the oxidation, in order to obtain the simplest possible separation of the aluminum oxide from the hydrogen likewise formed during the oxidation. As a result of the aluminum oxide formed having a particle size that is larger than the particle size of the aluminum used, the aluminum oxide can be separated in a simple manner.

The particle size of the aluminum oxide formed in the aluminum oxidation step can be regulated by suitably specifying reaction parameters such as, inter alia, by suitably specifying the particle size of the aluminum used, the temperature of the water used, the pressure in the aluminum reaction chamber, the oxidation temperature of the aluminum, and the ratio of the aluminum used to the water.

There is likewise the option of producing aluminum oxide nanoparticles in a targeted manner by suitably specifying said reaction parameters, which nanoparticles can in turn be used for subsequent industrial purposes. For this purpose, it can be provided that the produced aluminum oxide nanoparticles have a particle size between 1 and 1000 nm, preferably between 2 and 500 nm, and in particular between 5 and 40 nm.

According to an advantageous implementation, it is optionally provided that, in the aluminum oxidation step, aluminum oxide nanoparticles are produced in a range below 1 ppm, preferably below 0.15 ppm, and particularly preferably below 0.01 ppm. Here, the indication “ppm” relates to the entirety of the aluminum oxide formed during the oxidation, wherein nanoparticles of aluminum oxide are preferably not formed, as far as possible, during the oxidation. By suitably selecting the reaction parameters, such as, inter alia, pressure, temperature and oxidizer, the formation of nanoparticles can be largely prevented. It is advantageous to select the conditions during the oxidation of the aluminum such that this results in a heterogeneous C-type surface reaction of the aluminum particles. Therefore, it can be expected that the aluminum oxide particles formed are, for the most part, larger and heavier than the aluminum particles used for the reaction. The formation of only negligibly low quantities of aluminum oxide particles provides the advantage that they cannot be released into the environment as particulate matter and the few aluminum oxide particles formed do not have to be separated from the hydrogen that is likewise formed with a great deal of effort. This makes it possible for the aluminum oxide formed during the reaction of the aluminum with water to advantageously be separated and collected in a simple manner such that the aluminum oxide can be completely recirculated into aluminum in a separate step.

It is also optionally provided that the aluminum oxide formed in the aluminum oxidation step is separated from the hydrogen formed by means of a separation device. In this case, the separation device can be a centrifugal separator, by means of which the solid aluminum oxide can be separated from the gaseous hydrogen and optionally, where λ_{H2O}≥1, also from the water. In addition, separation can also take place aside from or also in addition to the separation by means of a centrifugal separator by means of filtration, wherein the reaction products of the reaction of the aluminum with water are conducted through a suitable filter in order to separate solid particles from the gaseous products.

In an advantageous implementation, it is optionally provided that, by suitably specifying the quantity of the aluminum used, the temperature of the water used, the pressure in the aluminum reaction chamber, and the ratio of the aluminum used to the water, the oxidation of the aluminum proceeds such that, in the aluminum oxidation step, the hydrogen formed leaves the aluminum reaction chamber at a temperature greater than 2200° C., preferably greater than 2500° C., and in particular greater than 2800° C. The temperature of the liberated hydrogen can be regulated by the quantity of the aluminum used for the oxidation, by the pressure in the reaction chamber, and also by the temperature of the water used and the ratio of water to aluminum, for example. The higher the temperature in the aluminum reaction chamber, the higher the temperature of the hydrogen. The higher the temperatures, the more energy can be obtained by means of the heat exchanger in the form of process heat during recovery.

It is also provided that the process heat produced in the aluminum oxidation step and/or in the water production step is removed in an energy conversion step. In this process, the process heat formed can be used in heat exchangers for steam production. The steam can, for the most part, be used to heat industrial processes, as district heating/local heating, or also for operating a steam turbine for CO₂-free power generation. In addition to the use of process heat, the hydrogen formed can likewise be used by means of heat exchangers for steam generation.

As already discussed, the steam can also be used to a minor extent, where necessary after cooling, to lower the temperature of the hydrogen reaction chamber.

Furthermore, it can be provided that the hydrogen produced in the aluminum oxidation step is at least partially converted into electrical power. To do this, the hydrogen formed can be used electrochemically in fuel cells or thermochemically for producing heat and electrical power.

It is also advantageously optionally provided that the hydrogen formed in the aluminum oxidation step is used at least partially to produce the water in the water production step. In addition to removing the hydrogen formed from the process and using it in heat exchangers, for storage or for reactions in fuel cells, the hydrogen can be returned to the cycle for a further reaction in the hydrogen reaction chamber.

It is also optionally provided that the hydrogen formed in the aluminum oxidation step and any water present is introduced into the aluminum reaction chamber. As a result, by circulation, the proportion of the recovered heat from the aluminum reaction chamber and also the hydrogen reaction chamber can be increased.

Further advantageous embodiments of the process according to the invention for conversion of energy in the form of process heat and hydrogen are shown in the following drawings:

### BRIEF DESCRIPTION OF THE DRAWINGS

FIG. 1 is a schematic view of a process for conversion of energy in the form of process heat and hydrogen.

FIG. 2 is a schematic view of a modified process from FIG. 1, wherein hydrogen formed is circulated in a cycle.

FIG. 3 is a schematic view of a process for conversion of energy in the form of process heat and hydrogen, wherein a hydrogen reaction chamber is arranged within an aluminum reaction chamber.

FIG. 4 is a schematic view of a process for conversion of energy in the form of process heat and hydrogen, with reaction parameters being indicated on the basis of a thermodynamic equilibrium calculation.

### DETAILED DESCRIPTION

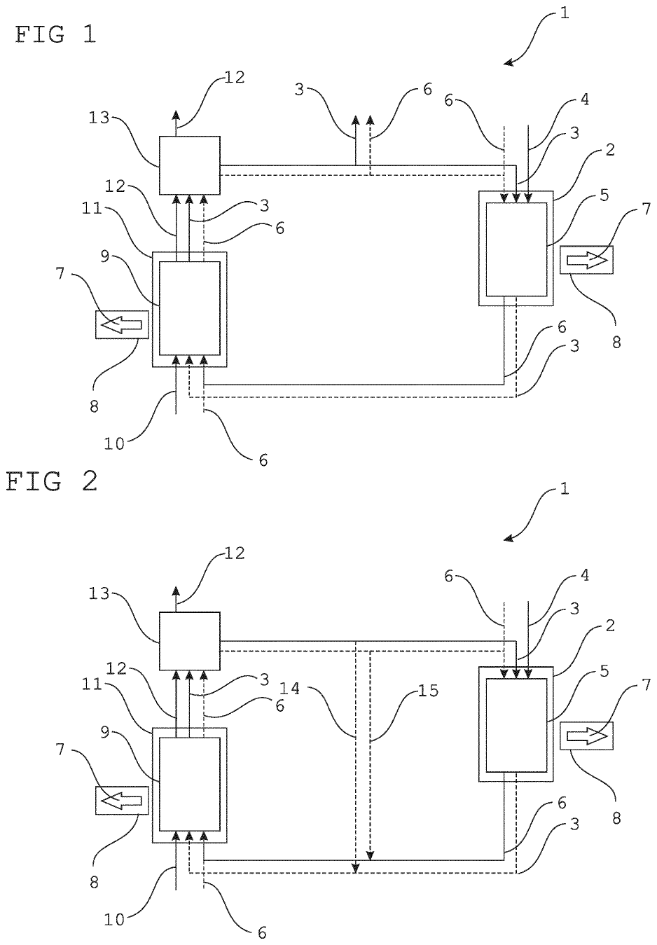

In FIG. 1, the process 1 for producing energy in the form of process heat and hydrogen is shown on the basis of a schematic drawing. In this figure, solid lines schematically represent paths along which individual products or starting materials are conducted. Dashed lines represent optional paths along which starting materials or products can optionally be conducted. Branches within the lines represent path junctions, at which starting materials or products can be conducted onwards along one path and/or the other path as desired.

In the process, aluminum is reacted with water, wherein aluminum oxide is formed and the energy chemically stored in the aluminum is converted in the form of process heat and hydrogen. The process 1 makes it possible for the energy conversion to be carried out without the emission of carbon dioxide and also for the formation of particulate matter in the form of nanoparticles to be prevented by controlling the temperature of the oxidation of the aluminum. Furthermore, the process heat, hydrogen and also steam can be flexibly extracted. This is also advantageously possible even in a high-temperature process.

In a water production step 2, hydrogen 3 is reacted together with oxygen 4, wherein water 6 is formed in a hydrogen reaction chamber 5 in a spontaneous and very rapid reaction in accordance with the reduced reaction equation H₂+½O₂→H₂O. In this process, the hydrogen 3 is stoichiometrically reacted with the oxygen 4, as a result of which water 6 is formed. During a superstoichiometric reaction with a greater quantity of hydrogen 3 than is required for producing the water 6, the excess hydrogen 3 can likewise be conducted onwards. In order to cool the hydrogen reaction chamber 5, the process heat 7 formed during the reaction of the hydrogen 3 with the oxygen 4 is removed in an energy conversion step 8, as a result of which the process heat can, for example, first be converted into steam by a heat exchanger, which steam can be directly used or used for power generation. The water 6 formed or any residues of hydrogen 3 present are conducted from the hydrogen reaction chamber 5 to an aluminum reaction chamber 9 at a temperature of greater than 2200° C. In the aluminum reaction chamber 9, the water 6 and any residues of hydrogen 3 from an incomplete reaction of the hydrogen 3 with oxygen 4 together with finely dispersed aluminum 10 are reacted in an aluminum oxidation step 11. In this process, the temperature required for the reaction is introduced by the water 6 introduced into the aluminum reaction chamber 9 at a temperature of greater than 2200° C., wherein the aluminum 10 is reacted with the water 6 to form ternary aluminum oxide 12. Furthermore, hydrogen 3 is likewise formed in addition to aluminum oxide 12. The process heat 7 that is formed during the reaction of the aluminum 10 is likewise removed and reused by means of a heat exchanger (not shown in the drawings) in the energy conversion step 8.

In order to prevent or at least reduce the formation of aluminum oxide nanoparticles 12, the water 6 used in the aluminum oxidation step 11 is used in an excess. For this purpose, the molar ratio λ_{H2O} of the water 6 introduced into the aluminum reaction chamber 9 to the stoichiometrically required water 6 λ_{H2O} can in particular be selected, as far as possible, such that 2H₂O is ≥1. In particular at temperatures above 2200° C., a ratio of λ_{H2O}<1 being used results in the formation of aluminum oxide nanoparticles 12 and other undesired particles, since incompletely oxidized aluminum oxide phases with aluminum 10 in the oxidation stage +1 such as Al₂O. When there is an excess of water 6 used, the excess water 6 that does not react with aluminum 10 to form aluminum oxide 12 is likewise conducted onwards in the same way as the hydrogen 3 formed.

Another aspect for preventing the formation of aluminum oxide nanoparticles 12 is the regulation of the temperature within the aluminum reaction chamber 9. In this case, the oxidation of the aluminum 10 in the micrometer range can be described on the basis of the adiabatic flame temperature T_{f} and the steam pressure T_{b} of the aluminum oxide 12 that is formed. In order to prevent the uncontrolled and undesired evaporation of the aluminum 10 during the reaction and therefore the formation of difficult-to-separate particulate matter of condensed aluminum oxide in the form of aluminum oxide nanoparticles 12, which make it difficult to recycle the metal oxide 12, it is advantageous for the ratio of T_{f} to T_{b} to be <1.

The aluminum particles 10 introduced into the aluminum reaction chamber 9 at least partially melt due to the exothermic reaction of aluminum 10 with the water 6, meaning that the aluminum 10 is largely or completely in liquid form. Owing to the water 6 as an oxidizer, during the oxidation of the aluminum 10 a growing oxide layer, from the particle surface towards the particle core, forms on the aluminum particles 10, which surround the potentially still partially solid particle cores. In this case, the mass of the aluminum-aluminum oxide particle increases due to the oxidation by the “addition” of oxygen. If the metal-oxide layer is porous, the density of the metal oxide is lower than that of the metal. The size of the oxidized metal particle then increases compared with the original metal particle, meaning that separation from the hydrogen 3 is made easier.

The aluminum oxide 12 formed in the aluminum oxidation step 11 is then separated from the hydrogen 3 that is formed and potentially from the water 6 in a separating device 13 formed as a centrifugal separator.

The hydrogen 3 formed, potentially as well as water 6, can then be removed from the cycle or can be returned to the cycle again at least partially. Furthermore, it is also possible to use the hydrogen 3 formed electrochemically in fuel cells or thermochemically for producing heat and electrical power simultaneously.

FIG. 2 is a schematic view of such a modified process 1 from FIG. 1, wherein the hydrogen 3 formed in the aluminum oxidation step 11 is not removed, but is returned to the hydrogen reaction chamber 5 and is used to produce water 6 in the water production step 2. Furthermore, the hydrogen 3 formed during oxidation can be guided along the hydrogen return path 14 and, where necessary, water 6 can be guided along the water return path 15 to the aluminum reaction chamber 9.

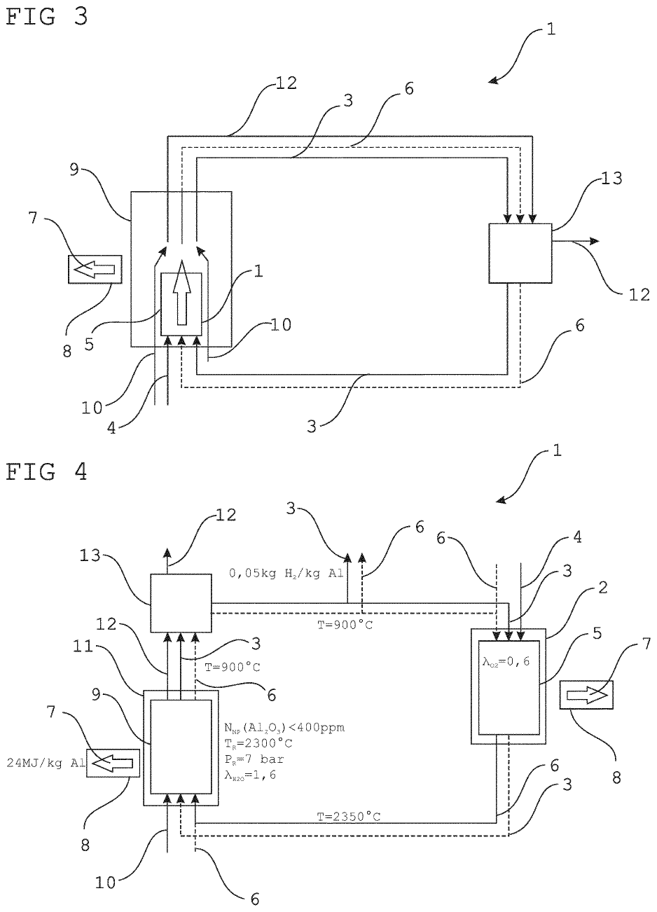

FIG. 3 schematically shows an integrated two-stage concept of the process. In this figure, the hydrogen reaction chamber 5 is located within the aluminum reaction chamber 9.

FIG. 4 schematically shows a process 1 based on the configuration from FIG. 1, wherein reaction parameters are indicated on the basis of the thermodynamic equilibrium calculation. In this figure, hydrogen 3 is reacted with oxygen 4 in the water production step 2 in the hydrogen reaction chamber 5, wherein water 6 is formed at a temperature T of 2350° C. Here, more hydrogen 3 is introduced into the hydrogen reaction chamber 5 than would be required for the production of the water 6 in order to achieve a complete reaction of the oxygen 3. To do this, the molar ratio 202 of the oxygen 3 introduced into the hydrogen reaction chamber 5 to the stoichiometrically required oxygen 3 is at a value of 0.6. The conditioned water 6 used in an excess of λ_{H2O}=1.6 is reacted in the aluminum reaction chamber 9 with aluminum 10 at a pressure PR of 7 bar and a temperature TR of the aluminum reaction chamber 9 of 2300° C., wherein the aluminum 10 is oxidized to form aluminum oxide 12. By suitably specifying reaction parameters, in this reaction only a negligibly small number of aluminum oxide particles 12 N_{NP}(Al₂O₃) of less than 400 ppm is formed. In this case, this stated quantity corresponds to the proportion of the nanoparticles Al₂O₃ in relation to the total quantity of particles of aluminum 10 and aluminum oxide 12 within the gas phase in chemical equilibrium. Here, process heat of 34 MJ per kilogram of aluminum used is removed from the aluminum reaction chamber 9 in the energy conversion step. The water 6 used in an excess leaves the aluminum reaction chamber 9 at a temperature T of 900° C. During the oxidation of the aluminum 10, 0.05 kg hydrogen 3 per kilogram of aluminum 10 used is also produced.

### LIST OF REFERENCE SIGNS

1 Process
2 Water production step
3 Hydrogen
4 Oxygen
5 Hydrogen reaction chamber
6 Water
7 Process heat
8 Energy conversion step
9 Aluminum reaction chamber
10 Aluminum
11 Aluminum oxidation step
12 Aluminum oxide
13 Separating device
14 Hydrogen return path
15 Water return path

1.-18. (canceled)

19. A process for converting energy, comprising:
reacting aluminum with water at elevated temperature in an aluminum reaction chamber in an aluminum oxidation step, thereby oxidizing the aluminum to form aluminum oxide and releasing process heat and hydrogen;
at least partially supplying the hydrogen released by reacting the aluminum and water to a hydrogen reaction chamber where the hydrogen reacts with oxygen to produce water in a water production step; and
supplying the water produced from the hydrogen to the aluminum reaction chamber for oxidizing the aluminum.

20. The process according to claim 19,
wherein the hydrogen is used in an excess in the water production step to produce the water.

21. The process according to claim 19, wherein, in the water production step, the water is produced at a temperature greater than 2200° C. for supplying into the aluminum reaction chamber.

22. The process according to claim 19, further comprising
regulating a temperature of the water produced in the hydrogen reaction chamber by introducing water from a water reservoir into the hydrogen reaction chamber.

23. The process according to claim 19, wherein the aluminum used in the aluminum oxidation step has a particle size between 1 and 1000 μm.

24. The process according to claim 19, further comprising
oxidizing, in the aluminum oxidation step, at least partially oxidized aluminum with water in the aluminum reaction chamber.

25. The process according to claim 19, wherein the water used for oxidizing the aluminum is used in an excess.

26. The process according to claim 19, wherein, at a specified pressure, an oxidation temperature of the aluminum in the aluminum oxidation step is below a boiling temperature of aluminum and aluminum oxide.

27. The process according to claim 19,
wherein, at a specified pressure, an oxidation temperature of the aluminum in the aluminum oxidation step is below a boiling temperature of aluminum, and
wherein the water used for oxidizing the aluminum is used in an excess, whereby the aluminum is completely oxidized by the water at a temperature below the boiling temperature of aluminum.

28. The process according to claim 19, wherein oxidizing the aluminum in the aluminum oxidation step is carried out at a pressure between 1.7 bar and 50 bar.

29. The process according to claim 19, wherein the aluminum oxide formed in the aluminum oxidation step has a larger particle size than the aluminum used for the oxidizing, in order to obtain simple separation of the aluminum oxide from the hydrogen formed during the oxidizing.

30. The process according to claim 19, wherein, in the aluminum oxidation step, aluminum oxide nanoparticles are produced in a range below 1 ppm.

31. The process according to claim 19, further comprising
separating the aluminum oxide formed in the aluminum oxidation step from the hydrogen by a separation device.

32. The process according to claim 19,
wherein, by specifying a quantity of the aluminum used, a temperature of the water used, a pressure in the aluminum reaction chamber, and a ratio of the aluminum used to the water, oxidizing the aluminum proceeds such that the hydrogen released by oxidizing the aluminum leaves the aluminum reaction chamber at a temperature greater than 2200° C.

33. The process according to claim 19, further comprising
removing the process heat released in the aluminum oxidation step and/or in the water production step in an energy conversion step.

34. The process according to claim 19, further comprising
at least partially converting the hydrogen released in the aluminum oxidation step into electrical power.

35. The process according to claim 19, further comprising
using the hydrogen released in the aluminum oxidation step at least partially for producing the water in the water production step.

36. The process according to claim 19, further comprising
introducing the hydrogen released in the aluminum oxidation step and any water present into the aluminum reaction chamber.
